(19) United States
(12) Patent Application Publication
(10) Pub. No.: US 2004/0114171 A1
(43) Pub. Date: Jun. 17, 2004

(54) Image forming apparatus and method for consolidated printing

(76) Inventors: Hidenori Shindoh, Tokyo (JP); Takao Okamura, Tokyo (JP); Fumihiro Umetsu, Tokyo (JP); Osamu Kizaki, Saitama (JP); Kiyotaka Moteki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/667,302

(22) Filed: Sep. 23, 2003

(30) Foreign Application Priority Data
Sep. 24, 2002 (JP) 2002-276676
Aug. 26, 2003 (JP) 2003-301778

(51) Int. Cl. G06F 15/00

(52) U.S. Cl. 358/1.13; 358/1.15

(57) ABSTRACT

An apparatus for forming an image, in which hardware resources for use in the forming of the image are provided, and a program runs in respect of the forming of the image. The apparatus includes an image data converting unit which converts a format of image data, and a format unifying unit which unifies a plurality of formats of image data by utilizing the image data converting unit.

### BACKGROUND OF THE INVENTION

1. Field of the Invention

The invention relates to an image forming apparatus that consolidates different types of image data, and relates to a method for consolidated printing.

2. Description of the Related Art

In recent years, an image forming apparatus (multifunction peripheral) that combines a plurality of machine-specific functions such as those of a printer, a copier, a facsimile machine, a scanner, etc., in one device has become widely popular. This multifunction peripheral is provided with a display unit, a print unit, an imaging unit, etc., in one device, and is also provided with four applications corresponding to a printer, a copier, a facsimile machine, and a scanner, respectively. Switching of the applications provides for the multifunction peripheral to perform any desired function of a printer, a copier, a facsimile machine, and a scanner.

Image data used in the printer, the copier, the facsimile machine, and the scanner may have different image formats. With reference to FIG. 15, a description will be given of a conventional method of consolidated printing for printing the different types of image data.

First, consolidated printing will be described. Consolidated printing refers to the printing of images on a single print sheet when these images are to be printed on respective print sheets. FIG. 15 is an illustrative drawing showing the way an image A and an image B are consolidated and printed on a single sheet of paper when these images are to be printed on respective sheets.

In FIG. 15, the image data of the images A and B consolidated and printed on a single sheet are either acquired by one of a printer, a copier, a facsimile device, and a scanner or obtained from a hard disk. The data types of the images A and B may differ.

When consolidated printing is applied to the image data of different types as described above, consolidated printing fails because of a difference in image types between the data of the image A and the data of the image B as shown in FIG. 16.

As shown in FIG. 17, it may be conceivable that data are unified into a single format that is either the data format of the image A or the data format of the image B, followed by printing the images. However, there are many types of data formats. Image data may be compressed data, for example. In such a case, image data needs to be decompressed by increments of an encoding unit, in order to learn how long such a data unit is. Moreover, consolidation of image data requires the size of images to be different from original size. That is, the resizing of images is necessary.

In this manner, consolidated printing requires heavy load processes such as decompression and resizing, resulting in difficulties to provide the consolidation of image data in a conventional multifunction peripheral.

Accordingly, there is a need for an image forming apparatus and a method for consolidated printing that efficiently consolidate and print the image data of varying types.

### SUMMARY OF THE INVENTION

It is a general object of the present invention to provide an image forming apparatus and a method for consolidated printing that substantially obviates one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by an image forming apparatus and a method for consolidated printing particularly pointed out in the specification in such full, clear, concise, and exact terms as to enable a person having ordinary skill in the art to practice the invention.

To achieve these and other advantages in accordance with the purpose of the invention, the invention provides an apparatus for forming an image, in which hardware resources for use in the forming of the image are provided, and a program runs in respect of the forming of the image, the apparatus including an image data converting unit which converts a format of image data, and a format unifying unit which unifies a plurality of formats of image data by utilizing the image data converting unit.

According to another aspect of the invention, the image data converting unit converts formats of image data used by a copier, a printer, a scanner, and a facsimile.

According to another aspect of the invention, the image data converting unit converts a format of image data by resizing an image of the image data, compressing the image data, decoding the image data, and attending to multi-value conversion of the image data.

According to another aspect of the invention, the image data converting unit converts the format of image data by hardware.

According to another aspect of the invention, the format unifying unit unifies the plurality of formats of image data into one of the plurality of formats.

According to another aspect of the invention, the format unifying unit includes a conversion executing unit which converts the image data by utilizing the image data converting unit according to a unified format.

According to another aspect of the invention, the format unifying unit includes a plurality of conversion executing units, one of which is the conversion executing unit, and others of which are identical to the conversion executing unit.

According to another aspect of the invention, the format unifying unit assigns the plurality of conversion executing units to respective images, thereby converting image data of the images.

According to another aspect of the invention, any given one of the conversion executing units converts image data of a corresponding one of the images by utilizing the image data converting unit if a format of the image data of the corresponding one of the images is different from the unified format.

According to another aspect of the invention, the apparatus as described above further includes a consolidated printing unit which consolidates and prints images whose formats are unified by the format unifying unit.

According to another aspect of the invention, the format unifying unit notifies the consolidated printed unit that image data is ready for consolidated printing if the format unifying unit completes unification of the formats of image data after conversion of at least one of the formats or because of no need for conversion of at least one of the formats.

According to another aspect of the invention, a method for consolidated printing by an image forming apparatus, in which hardware resources for use in forming of an image are provided, and a program runs in respect of the forming of the image, includes the steps of unifying a plurality of formats of image data by converting the formats of image data by hardware, and consolidating and printing image data whose formats are unified.

Other objects and further features of the present invention will be apparent from the following detailed description when read in conjunction with the accompanying drawings.

### BRIEF DESCRIPTION OF THE DRAWINGS

FIG. 1 is a block diagram showing an embodiment of a multifunction peripheral according to the invention;

FIG. 2 is a block diagram showing a hardware construction of an embodiment of the multifunction peripheral;

FIG. 3 is an illustrative drawing for explaining an MEU;

FIG. 4 is an illustrative drawing showing a plurality of image data formats stored in a hard disk drive;

FIG. 5 is an illustrative drawing showing the construction of an MLB;

FIG. 6 is an illustrative drawing showing a consolidation process;

FIG. 7 is a flowchart showing the consolidation process performed by two threads;

FIG. 8 is a sequence chart showing the detail of the consolidation process of FIG. 7;

FIG. 9 is an illustrative drawing showing another consolidation process for which image data is resized to conform to an assigned area;

FIG. 10 is an illustrative drawing showing the consolidation process of FIG. 9 by highlighting the function of two threads;

FIG. 11 is a sequence chart showing the detail of the consolidation process of FIG. 10;

FIG. 12 is an illustrative drawing showing another consolidation process;

FIG. 13 is an illustrative drawing showing the consolidation process of FIG. 12 by highlighting the function of two threads;

FIG. 14 is a sequence chart showing the detail of the consolidation process of FIG. 13;

FIG. 15 is an illustrative drawing showing a conventional method of consolidated printing for printing the different types of image data;

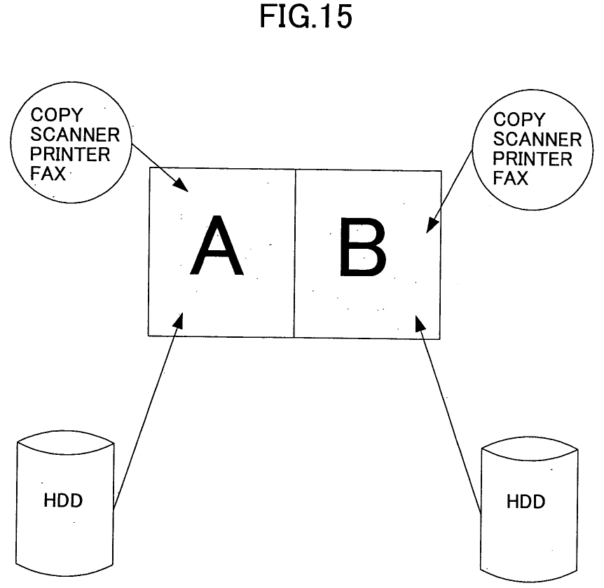

FIG. 16 is an illustrative drawing showing consolidated printing that fails because of a difference in image types; and

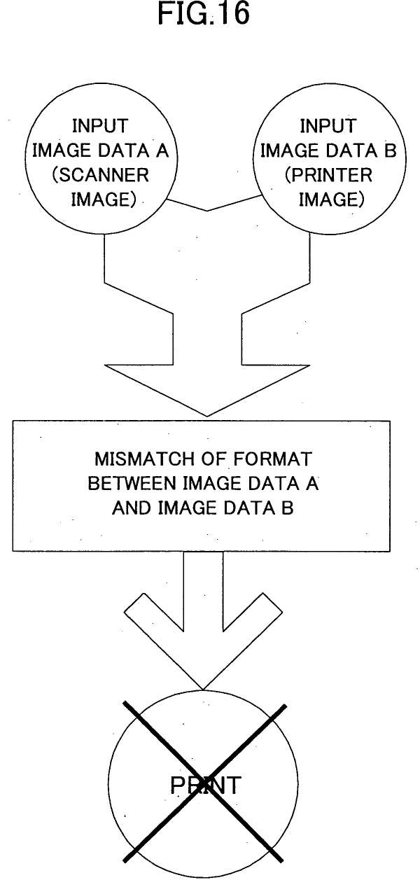

FIG. 17 is an illustrative drawing showing unification of data.

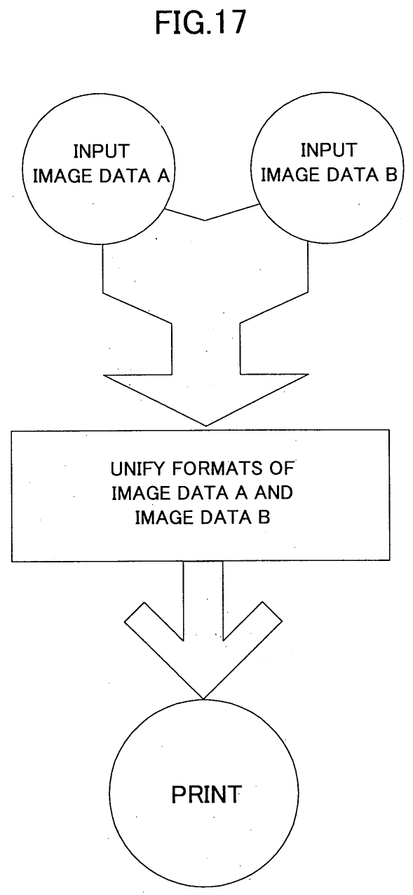

### DESCRIPTION OF THE PREFERRED EMBODIMENTS

In the following, embodiments of the present invention will be described with reference to the accompanying drawings.

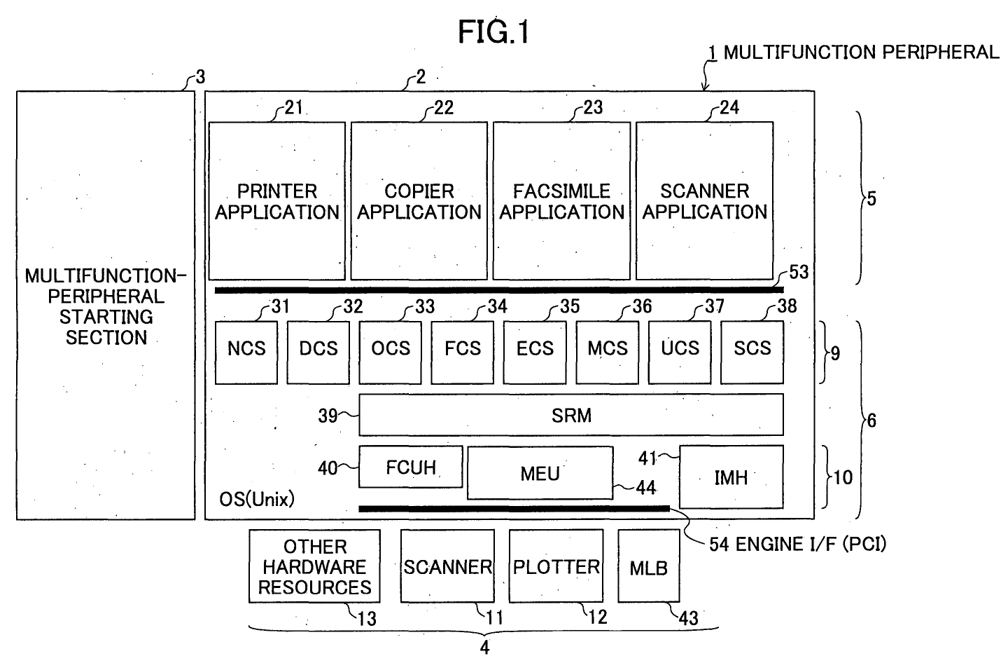

FIG. 1 is a block diagram showing an embodiment of a multifunction peripheral according to the invention. A multifunction peripheral 1 includes a software set 2, a multifunction-peripheral starting section 3, and hardware resources 4.

The multifunction-peripheral starting section 3 operates first upon the power-on of the multifunction peripheral 1, and starts an application layer 5 and a platform layer 6. For example, the multifunction-peripheral starting section 3 reads programs for the application layer 5 and the platform layer 6 from a hard disk drive (HDD) or the like, and transfers these programs to respective memory areas for execution. The hardware resources 4 include a scanner 11, a plotter 12, an MLB 43 serving as an image data converting unit for converting image data, and other hardware resources 13, which may include a facsimile and the like.

The software set 2 includes the application layer 5 and the platform layer 6, which are executed on an operating system (hereinafter referred to as an OS) such as UNIX (registered trademark). The application layer 5 includes programs for user-service-specific processes relating to image formation such as a printer, a copier, a facsimile, a scanner, etc.

The application layer 5 includes a printer application 21 used for a printer, a copier application 22 used for a copier, a facsimile application 23 used for a facsimile, and a scanner application 24 used for a scanner.

The platform layer 6 includes a control service layer 9 which interprets a processing request from the application layer 5 to generate a request for acquiring the hardware resources 4, a system resource manager (SRM) 39 which manages one or more hardware resources 4 to arbitrate acquisition requests from the control service layer 9, and a handler layer 10 which manages the hardware resources 4 in response to the acquisition request from the SRM 39.

The control service layer 9 is configured to include one or more service modules such as a network control service (NCS) 31, a delivery control service (DCS) 32, an operation panel control service (OCS) 33, a fax control service (FCS) 34, an engine control service (ECS) 35, a memory control service (MCS) 36, a user information control service (UCS) 37, and a system control service (SCS) 38.

The platform layer 6 is configured to include API 53 through a preset function, which makes it possible to receive a processing request from the application layer 5. The OS executes processes in parallel with respect to the software of the application layer 5 and the software of the platform layer 6.

The process of the NCS 31 provides services which are used by applications that need network I/O. This process serves as an intermediary to distribute data to each application as the data is received through respective protocols from networks and to transmit data to the networks as the data is received from each application.

For example, the NCS 31 controls data communication with network apparatus connected through the networks by HTTP (HyperText Transfer Protocol) by use of the httpd (HyperText Transfer Protocol Daemon).

The process of the DCS 32 controls distribution of accumulated documents and the like. The process of the OCS 33 controls an operation panel, which is used as an interface for communication between an operator and a control unit. The process of the FCS 34 provides API for performing fax transmission and reception through the PSTN or ISDN network for the application layer 5, the registration/referencing of various fax data stored in backup memory, fax scanning, received fax printing, etc.

The process of the ECS 35 controls engine units such as the scanner 11, the plotter 12, and the other hardware resources 13. The process of the MCS 36 performs memory control such as the acquisition and release of memory and the use of HDD, etc. The process of the UCS 37 manages user information.

The process of the SCS 38 attends to application management, operation-panel control, system screen display, LED display, hardware resource management, interruption application control, etc.

The process of the SRM 39 together with the SCS 38 attend to system control and the management of the hardware resources 4. For example, the process of the SRM 39 arbitrates in response to acquisition requests from the higher-order layers that are in need of using the hardware resources 4 such as the scanner 11 and the plotter 12, thereby performing execution control.

Specifically, the process of the SRM 39 checks whether the hardware resources 4 requested for acquisition are available (whether they are being used by other acquisition requests). If they are available, the process of the SRM 39 notifies the higher-order layer that the hardware resources 4 requested for acquisition are available. Moreover, the process of the SRM 39 attends to scheduling for use of the hardware resources 4 in response to the acquisition requests from the higher-order layers, and carries out what is requested (for example, paper feeding and imaging by the printer engine, memory allocation, file generation, etc.).

Moreover, the handler layer 10 includes a fax control unit handler (FCUH) 40 that controls and manages a fax control unit (FCU), which will be described later. The handler layer 10 further includes an image memory handler (IMH) 41, which manages the allocation of memory areas to processes and to manage the memory areas assigned to the processes. The SRM 39 and the FCUH 40 issue a processing request to the hardware resources 4 by use of an engine I/F 54, which enables transmission of the processing request to the hardware resources 4 by use of a predefined function.

The multifunction peripheral 1 uses the platform layer 6 to achieve central processing of various processes required by each application. In the following, the hardware construction of the multifunction peripheral 1 will be described.

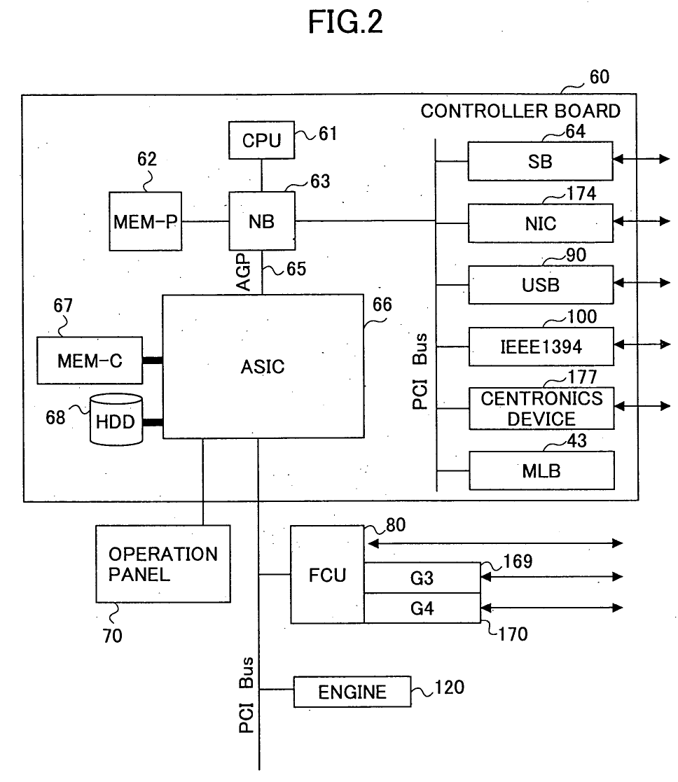

FIG. 2 is a block diagram showing a hardware construction of an embodiment of the multifunction peripheral 1. The multifunction peripheral 1 includes a controller board 60, an operation panel 70, a FCU 68, and an engine 71. The FCU 68 includes a G3-standard complying unit 169 and a G4-standard complying unit 170.

The controller board 60 includes a CPU 61, an ASIC 66, an HDD 68, a system memory (MEM-P) 62, a local memory (MEM-C) 67, a north bridge (NB) 63, a south bridge (SB) 64, a NIC 174 (Network Interface Card), a USB device 90, an IEEE1394 device 100, a Centronics device 177, and the MLB 43.

The operation panel 70 is connected to the ASIC 66 of the controller board 60. The SB 64, the NIC 174, the USB device 90, the IEEE1394 device 100, the Centronics device 177, and the MLB 43 are all connected to the NB 63 through the PCI bus.

The MLB 43 is a circuit board that is connected to the multifunction peripheral 1 through the PCI bus. The MLB 43 converts image data supplied from the multifunction peripheral 1, and supplies converted image data or coded image data to the multifunction peripheral 1.

The FCU 80 and the engine 120 are connected to the ASIC 66 of the controller board 60 through the PCI bus.

In addition, the controller board 60 has the local memory 67 and the HDD 68 connected to the ASIC 66, and the CPU 61 and the ASIC 66 are connected through the NB 63 of a CPU chip set. Connecting the CPU 61 and the ASIC 66 together through the NB 63 in this manner makes it possible to cope with such a situation as the interface of the CPU 61 is not released to the public.

The ASIC 66 and the NB 63 are connected not through the PCI bus but through AGP (accelerated graphics port) 65. In this manner, the ASIC 66 and the NB 63 are connected through the AGP 65 instead of the low-speed PCI bus, thereby avoiding a drop of performance when controlling the execution of one or more processes which form the application layer 5 and the platform layer 6 of FIG. 2.

The CPU 61 is responsible for overall control of the multifunction peripheral 1. The CPU 61 starts and executes the NCS 31, the DCS 32, the OCS 33, the FCS 34, the ECS 35, the MCS 36, the UCS 37, the SCS 38, the SRM 39, the FCUH 40, the IMH 41, and the MEU 44 as processes on the OS, and also starts and executes the printer application 21, the copy application 22, the fax application 23, and the scanner application 24, which make up the application layer 5.

The NB 63 is a bridge for connecting the CPU 61, the system memory 62, the SB 64, and the ASIC 66. The system memory 62 is used as a picture-rendering memory and the like of the multifunction peripheral 1. The SB 64 is a bridge for connecting the NB 63, the PCI bus, and peripheral devices. The local memory 67 is used as a copy-purpose image buffer and also as a code buffer.

The ASIC 66 is an image-processing-purpose IC that includes hardware elements for image processing. The HDD 68 is a storage for storing images, document data, programs, font data, forms, etc. The operation panel 70 is operated by a user to receive input data from the user, and attends to display presentation to the user.

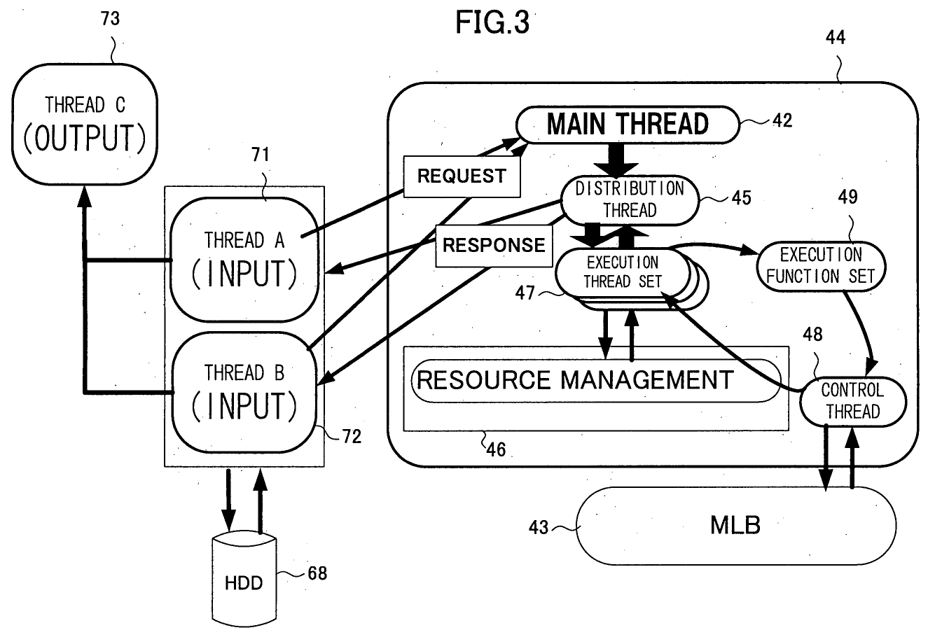

In the following, a description will be made of the MEU 44 that converts image data by use of the MLB 43 described in connection with FIG. 1. FIG. 3 is an illustrative drawing for explaining the MEU 44.

First, a description will be made of threads, which issue requests to the MEU 44. A thread A 71, a thread B 72, and a thread C 73 come to existence when the IMH 41 is generated or started. The thread A 71 and the thread B 72 issue a request for converting image data obtained by the copier, the printer, the scanner, or the fax machine or for converting image data stored in the HDD 68. The thread C 73 serves to output, to the engine 120 for carrying out a printing process, the image data that has a unified format provided by the thread A 71 and the thread B 72.

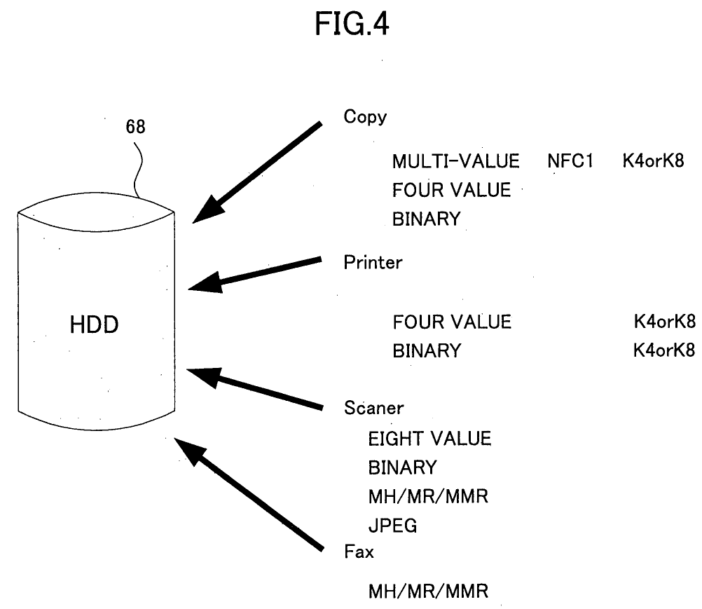

The HDD 68 stores documents in a plurality of image data formats as shown in FIG. 4. Formats used by a copier include a multi-value format, a four-value format, and a binary format as shown in the figure. A printer uses a four-value format and a binary format. A scanner uses an eight-value format, a binary format, an MH/MR/MMR format, and a JPEG format. A fax uses an MH/MR/MMR format. NFC1, K4, and K8 represent compression methods, and indicate respective formats.

Attention is now turned to the MEU 44. As shown in FIG. 3, the MEU 44 includes a main thread 42, a distribution thread 45, an execution thread 47 corresponding to a conversion executing unit, a resource management unit 46, a control thread 48, and an execution function set 49.

The main thread 42 receives a conversion request from the thread A 71 or the thread B 72. The distribution thread 45 delivers the conversion request to the execution thread 47 as the main thread 42 is informed of the request, and notifies a requesting thread of the completion of image data conversion. The execution thread 47 performs a conversion process responsive to the conversion request supplied from the distribution thread 45. The execution thread 47 takes care of conversion of a single image, so that a plurality of execution threads 47 are provided to achieve the conversion of a plurality of images.

The execution function set 49 is a set of functions for setting parameters that are required by the control thread 48 to control the MLB 43.

The control thread 48 controls the MLB 43, which is hardware. The resource management unit 46 is a module that manages and controls the resources of the MLB 43.

The thread is generally defined as a minimum unit of a divided piece when the OS executes a single process by dividing the process into pieces. The threads are executable in parallel through dispatch by the OS. In this embodiment, the threads are configured to transmit and receive mail. The mail may be referred to as a message depending on the type of the OS, and specifies information such as instructions and data that are exchanged between objects such as threads.

Exchange between the main thread 42, the thread 50, the distribution thread 45, the execution thread 47, and the control thread 48 is usually performed by mail.

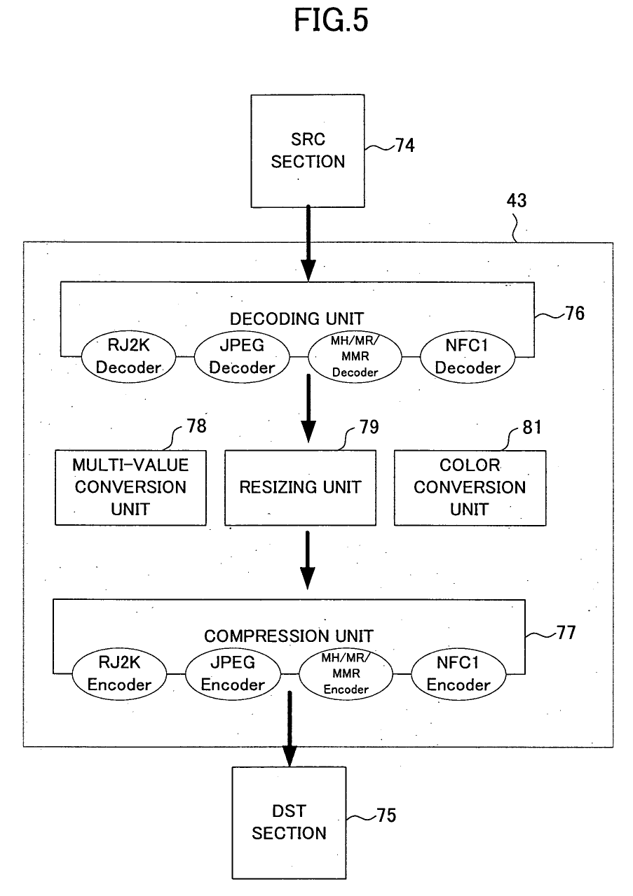

In the following, the MLB 43 will be described in detail with reference to FIG. 5. An SRC section 74 and a DST section 75 shown in the figure will first be described. These sections do not belong to the MLB 43. The SRC section 74 stores image data that is to be converted by the MLB 43. The DST section 75 stores image data that has been converted by the MLB 43.

In what follows, the MLB 43 will be described. The MLB 43 includes a decoding unit 76, a compression unit 77, a multi-value conversion unit 78, a resizing unit 79, and a color conversion unit 81.

A decoding unit 76 decodes (decompresses) compressed image data. The multi-value conversion unit 78 attends to data conversion into binary data, eight-value data, etc., as previously described. The resizing unit 79 changes the size of images by changing the image data of the A4 size into the image data of the A5 or A3 size, for example. The color conversion unit 81 converts the color of images. The compression unit 77 compresses image data which has undergone decoding, resizing, etc.

As shown in the figure, available image data formats include RJ2K, JPEG, MH/MR/MMR, and NFC1. These forms are used by a copier, a printer, a scanner, and a fax machine, and the MLB 43 can convert these image data formats.

In this manner, the MLB 43 is based on hardware, and performs the multi-value conversion, resizing, and color conversion of image data having different formats at high speed.

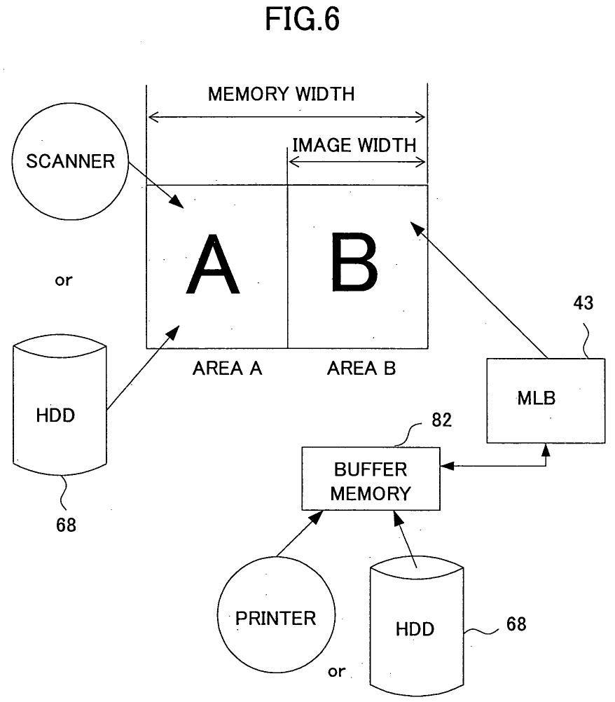

In the following, the detail of processing will be described. FIG. 6 is an illustrative drawing showing a consolidation process. As shown in FIG. 6, image data to be consolidated includes image data in an area A obtained from a scanner or obtained from documents stored in the HDD 68, and further includes image data in an area B obtained from a printer or from documents stored in the HDD 68 through conversion by the MLB 43. Here, the buffer memory 82 is the SRC section 74 and the DST section 75 which were described in connection with FIG. 5. In FIG. 6, an illustrated memory width corresponds to the width of a printing sheet, and an illustrated image width corresponds to the width of the area B.

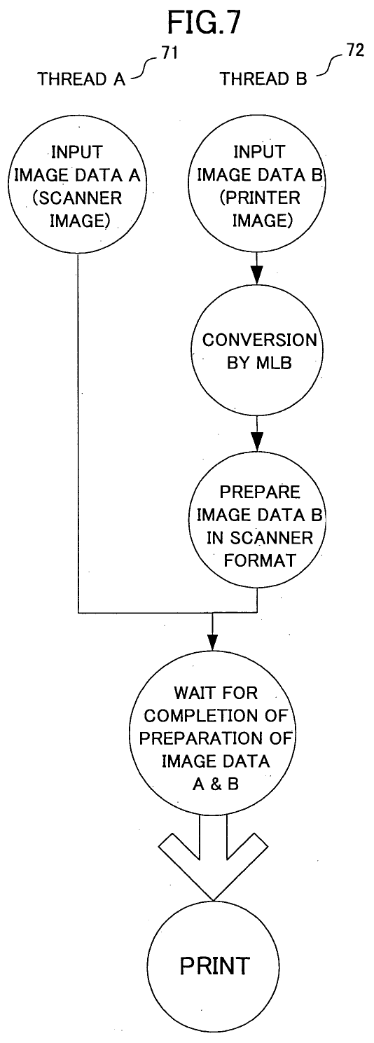

In the following, a description will be given of the process by highlighting the function of the thread A 71 and the thread B 72 which convert image data by use of the MLB 43 according to the unified format. FIG. 7 is a flowchart showing the process performed by the thread A 71 and the thread B 72. This process converts the image data of the thread B 72 into image data in the scanner format by use of the MLB 43. First, a description will be given of image data which is input by each thread.

The thread A 71 receives image data A having a scanner format. The thread B 72 receives image data B having a printer format.

These different formats of the image data corresponding to the scanner and the printer are unified into one of the formats, which is the scanner format in this case, thereby consolidating the image data. Such unification is carried out by the plurality of threads mentioned above. One piece of image data is assigned to each of the thread A 71 and the thread B 72. When the format of the assigned image data is different from the unified format, the thread, which is the thread B 72 in this case, uses the MLB 43 to convert the assigned image data.

The process of FIG. 7 will be described below. Since the thread A 71 does not need data conversion, it is ready for consolidation. The thread B 72 converts the image data B from the printer format into the scanner format by use of the MLB 43, thereby preparing for consolidation. When the two threads are ready for the consolidation of image data, the image data A and B are consolidated for printing.

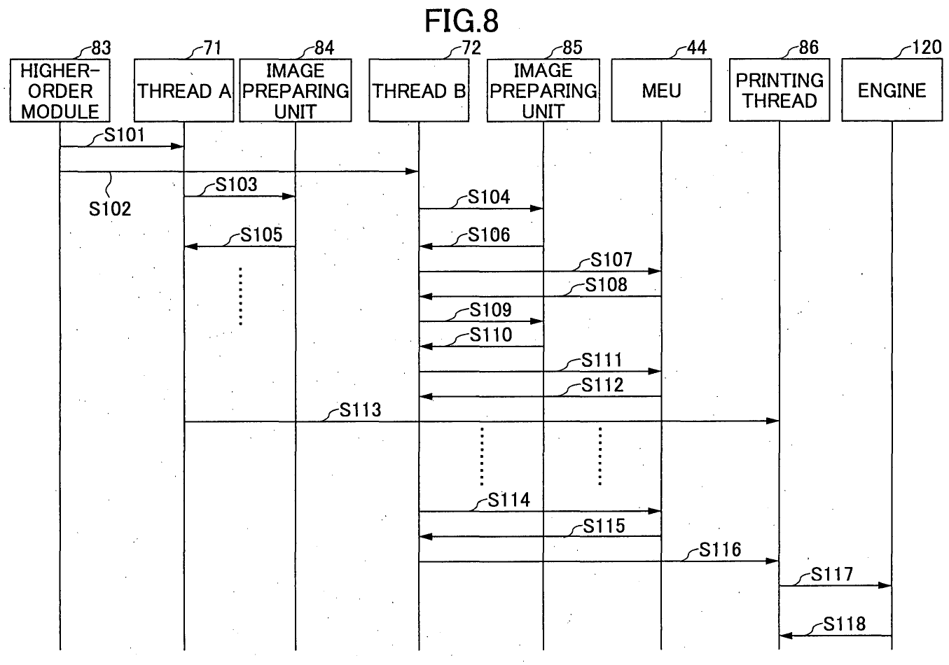

FIG. 8 is a sequence chart showing the detail of the process described above. In FIG. 8, a higher-order module 83 is provided for the purpose of sending a request to the thread A 71 and the thread B 72 so as to unify the formats of image data and to consolidate the image data. The higher-order module 83 and the collective of threads serve as a format unifying unit.

Image preparing units 84 and 85 prepare image data that are to be consolidated by the thread A 71 and the thread B 72. The image preparing units 84 and 85 obtain image data from a copier, a fax machine, the HDD 68, etc. The MEU 44 is a module which converts the image data by use of the MLB 43′ as described above. A printing thread 86 controls the engine 120 to print the consolidated image data prepared by the thread A 71 and the thread B 72, and corresponds to an consolidated printing unit. Here, the thread A 71 and the thread B 72 do not receive the entirety of image data at once from the image preparing units 84 and 85, respectively, but receive the image data piece by piece.

In the following, a description will be given with reference to the sequence chart. At steps S101 and S102, the higher-order module 83 sends a request for preparing image data for consolidation to the thread A 71 and the thread B 72. In response, the thread A 71 requests the image preparing unit 84 at step S103 to prepare an image. At step S105, the thread A 71 is notified by the image preparing unit 84 that the preparation of image data is done. Thereafter, the thread A 71 receives the image data piece by piece for preparation of consolidation. When the entirety of image data is prepared, the thread A 71 notifies the printing thread 86, at step S113, that the preparation of image data is done.

The thread B 72 requests the image preparing unit 85 at step S104 to prepare an image, and is notified by the image preparing unit 84, at step S106, that the preparation of image data is completed.

In order to convert the image data, the thread B 72 requests the MEU 44 at step S107 to convert the image data. After the conversion of image data is completed, the MEU 44 notifies the thread B 72 of the completion of data conversion at step S108. Here, the thread B 72 issues a notice indicative of a memory width corresponding to the width of the printing sheet, an image width corresponding to the width of the area B (see FIG. 6), and a start address of a memory area where the converted image data is to be stored. By this procedure, the converted image data is stored in the area B.

Then, the thread B 72 again has the image preparing unit 85 prepare image data at steps S109 and S110. At steps S111 and S112, the thread B 72 has the MEU 44 convert the image data.

When the conversion of all image data is completed at steps S114 and S115, the thread B 72 notifies the printing thread 86 that the creation of image data is completed.

In response to the notices from the thread A 71 and the thread B 72 that the creation of image data is completed, the printing thread 86 sends a request for start of printing to the engine 120 at step S117, and is notified by the engine 120 at step S118 that printing is completed.

In this manner, the thread A 71 and the thread B 72 unify the two different formats of image data into one of the formats, which in this case is the format assigned to the thread A 71.

When there is no need to convert the assigned image data as in the case of the thread A 71 or when the conversion of the assigned image data is completed as in the case of the thread B 72, a notice is sent to the printing thread 86 to indicate the completion of image data preparation.

In response to the notices from all the threads that the preparation of image data is done, the printing thread 86 arranges to print the consolidated image data having the unified format on a printing sheet. Step S103 through step S115 correspond to a format unifying step. Step S117 and step 118 correspond to a printing step.

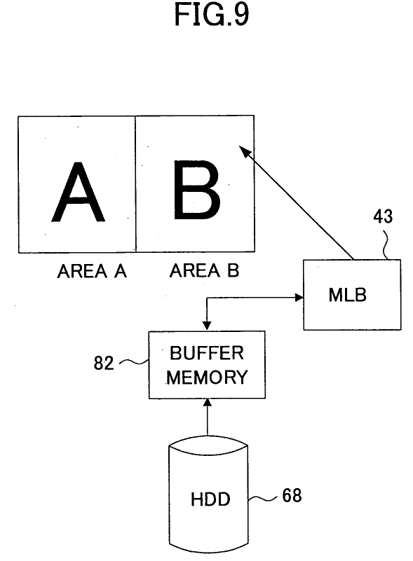

In the following, a description will be given of a process performed by the MLB 43 that resizes an image obtained from documents stored in the HDD 68. As shown in FIG. 9, this process performed by the MLB 43 resizes image data to make it conform to the area B.

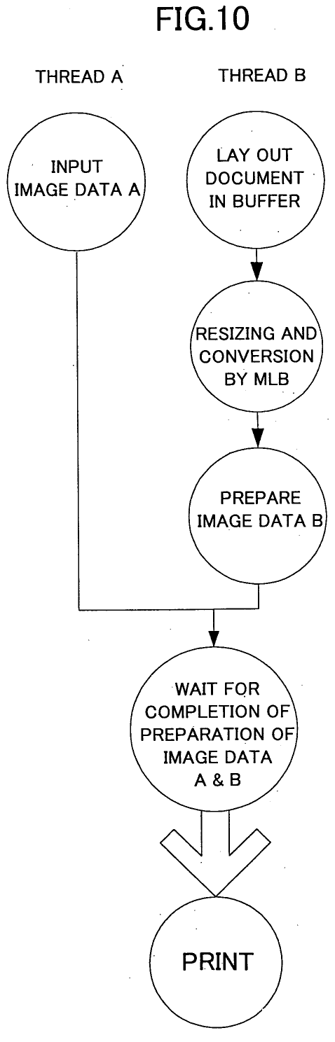

In the following, the process will be described with reference to FIG. 10 by highlighting the function of the thread A 71 and the thread B 72. First, a description will be given of image data which is input by each thread.

The thread A 71 receives image data A having a scanner format, a copier format, or the like. The thread B 72 receives image data B from the documents stored in the HDD 68.

The process of FIG. 10 will be described below. Since the thread A 71 does not need data conversion, it is ready for consolidation. The thread B 72 uses the MLB 43 to convert the image data B from the format of the document image data laid out in a buffer memory 82 into the format of image data received by the thread A 71, thereby preparing for consolidation.

The MLB 43 can attend to both resizing and conversion at the same time as shown in the figure. In conventional procedures, conversion is performed after resizing is done. This is not only time consuming, but also requires excess memory areas for allocation to the resizing process and for allocation to the conversion process. The use of the MLB 43 brings about improvements in terms of memory space and conversion speed.

When the two threads are ready for the consolidation of image data, the image data A and B are consolidated for printing.

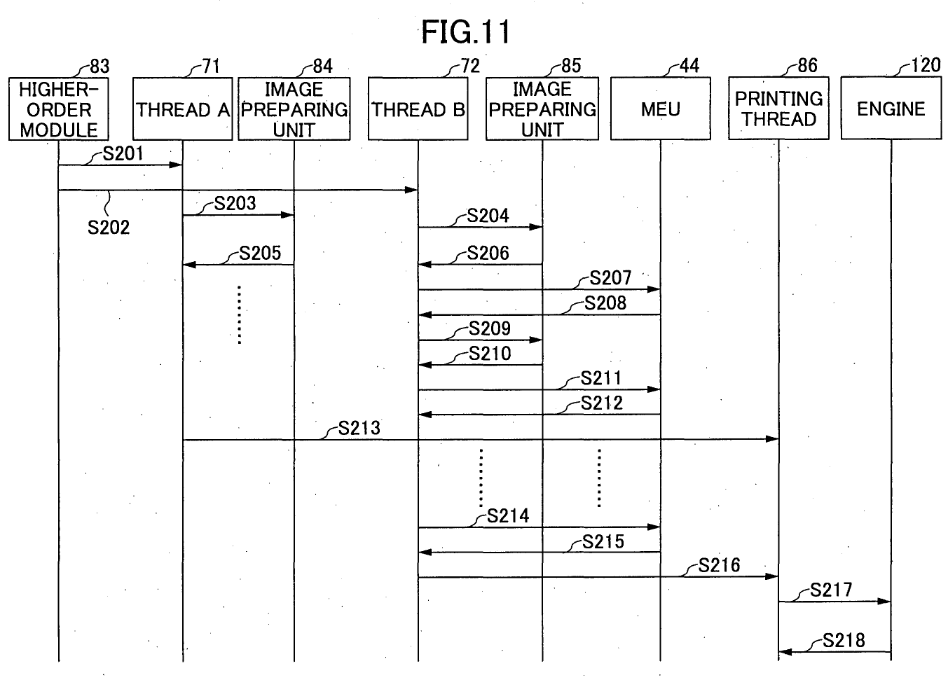

FIG. 11 is a sequence chart showing the detail of the process described above. At steps S201 and S202, the higher-order module 83 sends a request for preparing image data for consolidation to the thread A 71 and the thread B 72. In response, the thread A 71 requests the image preparing unit 84 at step S203 to prepare an image. At step S205, the thread A 71 is notified by the image preparing unit 84 that the preparation of image data is done. When the entirety of image data is prepared, the thread A 71 notifies the printing thread 86, at step S213, that the preparation of image data is completed.

The thread B 72 requests the image preparing unit 85 at step S204 to prepare an image, and is notified by the image preparing unit 84, at step S206, that the preparation of image data is completed.

In order to convert the image data, the thread B 72 requests the MEU 44 at step S207 to convert the image data. After the conversion of image data is completed, the MEU 44 notifies the thread B 72 of the completion of data conversion at step S208. Here, the thread B 72 issues a notice indicative of a memory width corresponding to the width of the printing sheet, an image width corresponding to the width of the area B (see FIG. 6), and a start address of a memory area where the converted image data is to be stored.

Then, the thread B 72 again has the image preparing unit 85 prepare image data at steps S209 and S210. At steps S211 and S212, the thread B 72 has the MEU 44 convert the image data.

When the conversion of all image data is completed at steps S214 and S215, the thread B 72 notifies the printing thread 86 that the creation of image data is completed.

In response to the notices from the thread A 71 and the thread B 72 that the creation of image data is completed, the printing thread 86 sends a request for start of printing to the engine 120 at step S217, and is notified by the engine 120 at step S218 that printing is completed.

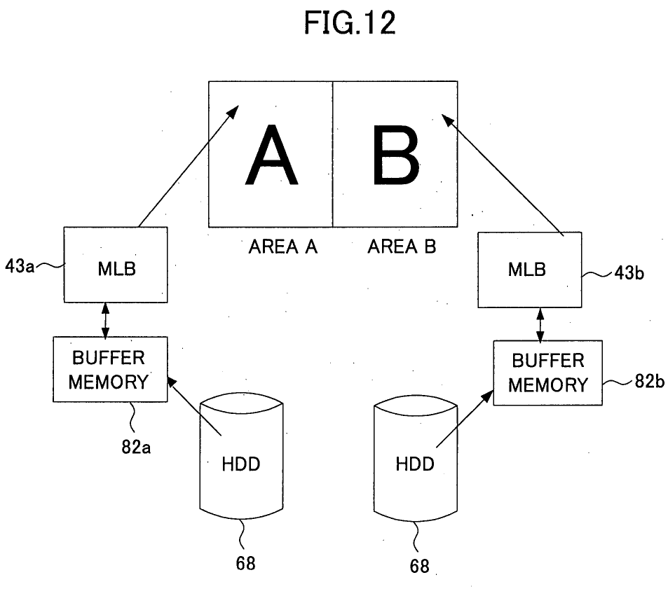

In the following, a description will be given of a consolidating process in which two MLBs are used. As shown in FIG. 12, image data to be consolidated includes image data that is obtained from the documents stored in the HDD 68 and converted by an MLB 43a for the area A, and includes image data that is obtained from the documents stored in the HDD 68 and converted by an MLB 43b for the area B.

The use of the two MLBs as described above may become relevant when two different formats of image data are unified into another different format.

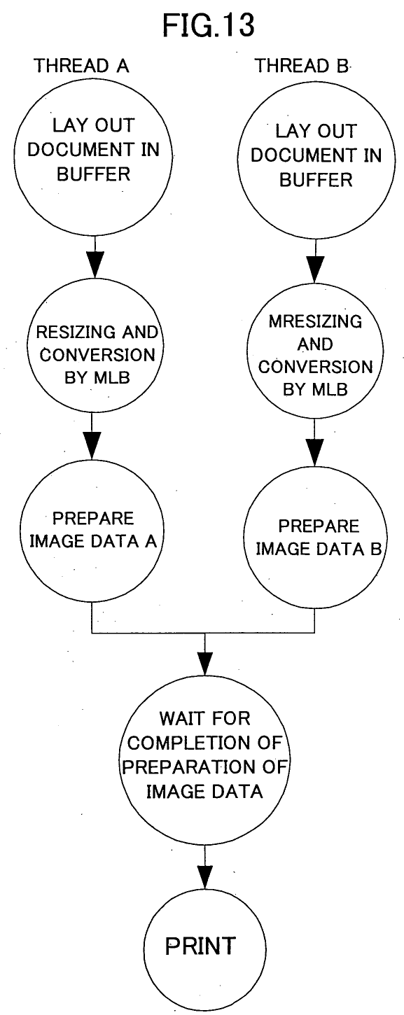

FIG. 13 is an illustrative drawing showing the consolidation process by highlighting the function of the thread A 71 and the thread B 72.

The thread A 71 uses the MLB 43 to convert the image data A from the format of document image data laid out in a buffer into a desired format, thereby preparing for consolidation. By the same token, the thread B 72 uses the MLB 43 to convert the image data B from the format of document image data laid out in a buffer into the desired format, thereby preparing for consolidation.

When the two threads are ready for the consolidation of image data, the image data A and B are consolidated for printing.

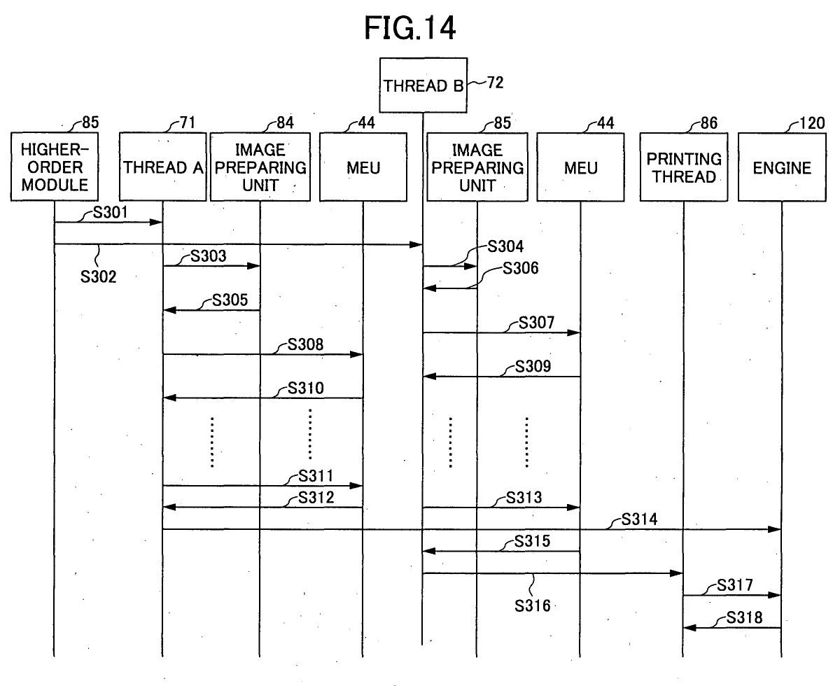

FIG. 14 is a sequence chart showing the detail of the process described above. At steps S301 and S302, the higher-order module 83 sends a request for preparing image data for consolidation to the thread A 71 and the thread B 72. In response, the thread A 71 requests the image preparing unit 84 at step S303 to prepare an image. At step S305, the thread A 71 is notified by the image preparing unit 84 that the preparation of image data is done.

Similarly, the thread B 72 requests the image preparing unit 85 at step S304 to prepare an image, and is notified by the image preparing unit 85, at step S306, that the preparation of image data is completed.

In order to convert the image data, the thread A 71 requests the MEU 44 at step S308 to convert the image data. After the conversion of image data is completed, the MEU 44 notifies the thread A 71 of the completion of data conversion at step S310.

Similarly, the thread B 72 requests the MEU 44 at step S307 to convert the image data. After the conversion of image data is completed, the MEU 44 notifies the thread B 72 of the completion of data conversion at step S309.

Thereafter, the thread A 71 and the thread B 72 repeat the conversion processes. When the thread A 71 finishes the conversion of the last fragment of image data at steps S311 and 312, the thread A 71 notifies the printing thread 86 at step S314 that the creation of image data is completed.

By the same token, when the thread B 72 finishes the conversion of the last fragment of image data at steps S313 and 315, the thread B 72 notifies the printing thread 86 at step S316 that the creation of image data is completed.

In response to the notices from the thread A 71 and the thread B 72 that the creation of image data is completed, the printing thread 86 sends a request for start of printing to the engine 120 at step S317, and is notified by the engine 120 at step S318 that printing is completed.

The use of a plurality of MLBs as described above provides for efficient and high speed consolidation of printer-format image data and copier-format image data into the facsimile format, for example, followed by transmitting the obtained facsimile image.

Although the embodiments described above have been directed to the consolidated printing of two images, three or more images can also be consolidated for printing.

If there are three images, for example, a thread D in addition to the threads A and B may run. These threads specify the image width and the memory width as described above for the MLB, so that the MLB converts image data while attending to the resizing of the data, thereby providing for consolidated printing for the three images.

Further, the present invention is not limited to these embodiments, but various variations and modifications may be made without departing from the scope of the present invention.

The present application is based on Japanese priority application No. 2002-276676 filed on Sep. 24, 2002, and Japanese priority application No. 2003-301778 filed on Aug. 26, 2003, with the Japanese Patent Office, the entire contents of which are hereby incorporated by reference.

What is claimed is:

1. An apparatus for forming an image, in which hardware resources for use in the forming of the image are provided, and a program runs in respect of the forming of the image, said apparatus comprising:
an image data converting unit which converts a format of image data; and
a format unifying unit which unifies a plurality of formats of image data by utilizing said image data converting unit.

2. The apparatus as claimed in claim 1, wherein said image data converting unit converts formats of image data used by a copier, a printer, a scanner, and a facsimile.

3. The apparatus as claimed in claim 1, wherein said image data converting unit converts a format of image data by resizing an image of the image data, compressing the image data, decoding the image data, and attending to multi-value conversion of the image data.

4. The apparatus as claimed in claim 1, wherein said image data converting unit converts the format of image data by hardware.

5. The apparatus as claimed in claim 1, wherein said format unifying unit unifies the plurality of formats of image data into one of the plurality of formats.

6. The apparatus as claimed in claim 1, wherein said format unifying unit includes a conversion executing unit which converts the image data by utilizing said image data converting unit according to a unified format.

7. The apparatus as claimed in claim 6, wherein said format unifying unit includes a plurality of conversion executing units, one of which is said conversion executing unit, and others of which are identical to said conversion executing unit.

8. The apparatus as claimed in claim 7, wherein said format unifying unit assigns the plurality of conversion executing units to respective images, thereby converting image data of the images.

9. The apparatus as claimed in claim 8, wherein any given one of said conversion executing units converts image data of a corresponding one of the images by utilizing said image data converting unit if a format of the image data of the corresponding one of the images is different from the unified format.

10. The apparatus as claimed in claim 1, further comprising a consolidated printing unit which consolidates and prints images whose formats are unified by said format unifying unit.

11. The apparatus as claimed in claim 10, wherein said format unifying unit notifies said consolidated printed unit that image data is ready for consolidated printing if said format unifying unit completes unification of the formats of image data after conversion of at least one of the formats or because of no need for conversion of at least one of the formats.

12. A method for consolidated printing by an image forming apparatus, in which hardware resources for use in forming of an image are provided, and a program runs in respect of the forming of the image, said method comprising the steps of:
unifying a plurality of formats of image data by converting the formats of image data by hardware; and
consolidating and printing image data whose formats are unified.
